(19) United States
(12) Patent Application Publication
(10) Pub. No.: US 2017/0372315 A1
(43) Pub. Date: Dec. 28, 2017

(54) METHOD AND SYSTEM FOR ACCESS CONTROL

(71) Applicant: SKIDATA AG, Grödig/Salzburg (AT)

(72) Inventor: Helmut DANZL, Hof bei Salzburg (AT)

(21) Appl. No.: 15/616,967

(22) Filed: Jun. 8, 2017

(30) Foreign Application Priority Data
Jun. 24, 2016 (EP) 16176210.9

(51) Int. Cl. G06Q 20/40; G06Q 20/32; G06Q 20/34; G07C 9/00

(52) U.S. Cl. CPC G06Q 20/4014; G07C 9/00119; G06Q 20/3224; G06Q 20/34

(57) ABSTRACT

A method for access control in an access control system for vehicles is proposed comprising at least one access control device, in the context of which by a display device of the at least one access control device facing an incoming vehicle in the access direction, a unique text assigned to the respective access control device is displayed which, due to the design and/or arrangement of the display device, is only visible in a defined area around the access control device. Under normal operating conditions, only one vehicle can be located in the defined area around the access control device. The displayed text is used to control the access control device in accordance with data transmitted to the access control system by a mobile electronic device (1), into which the text is dictated by a user.

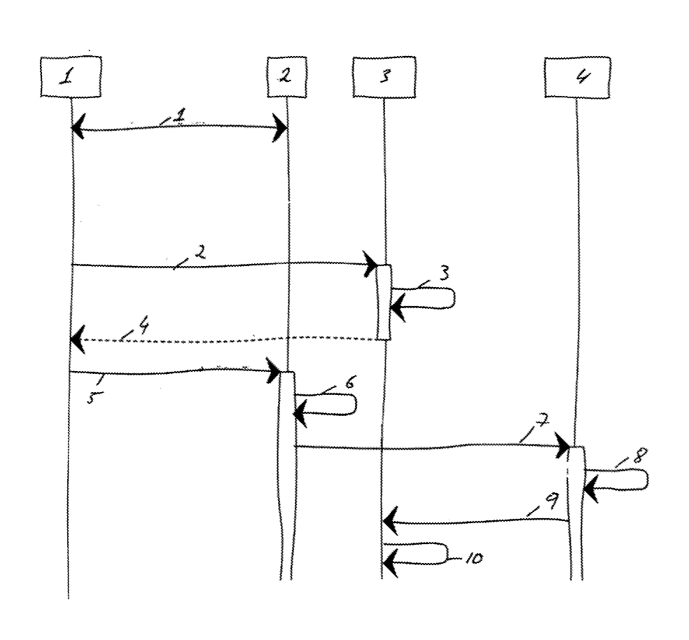

This application claims priority from European patent application serial no. 16178210.9 filed Jun. 24, 2016.

### FIELD OF THE INVENTION

The present invention relates to a method for access control in an access control system for vehicles, comprising at least one access control. The invention also relates to an access control system for vehicles, comprising at least one access control device, in particular to an access control system for implementing the method according to the invention.

### BACKGROUND OF THE INVENTION

Methods and systems for access control for vehicles are known from the prior art. In these cases, access control is normally carried out by means of the reading of access authorizations, wherein access control devices are provided which have means for capturing and evaluating the access authorizations as well as locking elements, either mechanical or implemented by other means, which are automatically or manually moved from a locked position into an open position when a valid access authorization is presented.

### SUMMARY OF THE INVENTION

The object of the present invention is to specify a method for access control in an access control system for vehicles, comprising at least one access control device, the implementation of which simplifies the access control. In addition, an access control system for vehicles comprising at least one access control device, in particular an access control system for implementing the method according to the invention, will be specified.

Accordingly, a method for access control in an access control system tor vehicles is proposed, comprising at least one access control device, in the context of which by means of a display device of the at least one access control device, which faces an incoming vehicle in the access direction, a unique text assigned to the respective access control device is displayed, which due to the design and/or arrangement of the display device is only visible or legible in a defined area around the access control device in which under normal operating conditions only one vehicle can be located, wherein the displayed text is used to control the access control device in accordance with data transmitted to the access control system by a mobile electronic device, into which the text is dictated by a user.

The text displayed by the display device can be changed at specified time intervals. The text can also be displayed permanently, in specified periodic intervals or after detection of a vehicle by means of a suitable known sensor from the prior art.

Because the text displayed by a display device assigned to an access control device is visible or legible only in a defined area around the access control device, in which under normal operating conditions only one vehicle can be located, the text is dictated into the mobile electronic device when the user of the mobile electronic device, or the person who is carrying it, is situated in a vehicle in the access lane directly before the junction between the area covered by the access control system and the coverage area which is not covered by the access control system. An access control mechanism in the sense of the invention may be assigned to an entrance or an exit, wherein at the exit it is verified whether the fee for staying in the coverage area of the access control system has been paid. The access control devices are connected to a server for the purpose of transferring data.

In accordance with one design of the invention, if a vehicle is in the access direction in the defined region in which the text is visible, the text is dictated into a mobile electronic device by a vehicle occupant, wherein the dictated text is transcribed into text by a piece of software in the mobile electronic device, for example by an app, and wherein via a suitable communication channel, for example by means of WLAN, Bluetooth Low Energy (BLE) or mobile radio, preferably using the app that is used for the transcription of the dictated text, information items are transmitted to a server of the access control system, which contain the transcribed text and identification data of the user who is carrying the mobile electronic device, comprising at least one unique ID of the user or of the mobile electronic device, wherein a locking element of the access control device to which the transcribed text is assigned is activated in the opening direction if, upon entering the area covered by the access control system, the user is identified as a registered user on the basis of the ID of the user or of the mobile electronic device, or if the user can be uniquely identified on the basis of the identification data of the user, or if on leaving the area covered by the access control system the necessary fees have been paid, which in the case of a registered user is effected by debiting his account or a credit card and in the case of a non-registered user by a cash or credit card payment, wherein in the case of a registered user the payment of the fees takes place automatically and in the case of a non-registered user during the payment the ID of the user or of the mobile electronic device is scanned or transmitted to the access control system via a piece of software in the mobile electronic device, for example by means of the app which is used for the transcription.

As an alternative to the transcription of the dictated text by a piece of software in the mobile electronic device, the dictated text, i.e. the corresponding audio file and identification data of the user who is carrying the mobile electronic device, comprising at least one unique ID of the user or of the mobile electronic device, via a suitable communication channel, for example by means of WLAN, Bluetooth Low Energy (BLE) or mobile radio and a piece of software in the mobile electronic device, preferably using an app, can be transmitted to a server of the access control system, wherein in the server the dictated text is transcribed into a text and a locking element of the access control device, to which the transcribed text is assigned, is activated in the opening direction if, upon entering the area covered by the access control system, the user is identified as a registered user on the basis of the ID of the user or of the mobile electronic device, or if the user can foe uniquely identified on the basis of the identification data of the user, or if on leaving the area covered by the access control system the necessary fees have been paid, which in the case of a registered user is effected by debiting his customer account or a credit card, and in the case of a non-registered user by cash or credit card payment, wherein in the case of a registered user the payment of the fees takes place automatically and in the case of a non-registered user during the payment the ID of the user or of the mobile electronic device is scanned or transmitted via a piece of software in the mobile electronic device, for example via the app, to the access control system.

In the context of one design of the invention, the app can be activated via a predefined voice command. In order to implement the communication channel the equipment best known to the person skilled in the art is provided; for example, for the case where the communication channel is based on the BLE standard, BLE-send/receive units are provided, which are connected to a server of the access control system for the purpose of transferring data.

On the basis of the text transmitted to the server or of the text transcribed in the server, which text is assigned to an access control device, the access control device is identified in the access lane of which the user of the mobile electronic device, or the person who is carrying it, is situated in a vehicle directly in front of the junction between the area covered by the access control system and the area which is not covered by the access control system.

If the user is not a registered user, he can register using the app and open a customer account, which can optionally contain credit card data.

In the context of another design of the invention, via the communication channel via which the identification data of the user and the transcribed text or the dictated text, i.e. the corresponding audio file, are transmitted to the server for transcription, an electronic ticket is transmitted by the server to the mobile electronic device, wherein before driving away the required fees are paid by means of a piece of software in the mobile electronic device, for example by means of the app used for the transcription or for the transmission of the audio file, and credit card data or at suitable machines, wherein as part of the payment process the ID of the user or of the mobile electronic device is transmitted to the server.

For example, the electronic ticket can contain a bar code, which in order to pay the fees is scanned by a payment machine comprising a barcode scanner. On driving away, on the basis of the ID of the user or of the mobile electronic device it is ascertained whether the fees have been paid, wherein if this is in fact the case, a locking element of the access control device, to which the transcribed text is assigned, is activated in the opening direction.

In accordance with the invention an access control system, for vehicles comprising at least one access control device is proposed, in which the at least one access control device comprises a display device facing the incoming vehicles, by means of which a unique text assigned to the respective access control device can be displayed, which due to the design and/or arrangement of the display device is visible only in a defined area around the access control device, in which under normal operating conditions only one vehicle can be located.

The at least one access control device comprises, for example, according to the prior art a parking bollard and a barrier arm; according to the invention the display device can be mounted on the barrier arm or the parking bollard, or be integrated in the barrier arm or in the parking bollard. In addition, as the display device an already existing display device can be used.

According to an extension of the invention, the sides of the barrier arm or of the parking bollard that can be turned to face incoming vehicles in accordance with the access direction, can each comprise a display device, wherein on the basis of the signals from a sensor, for example an induction loop, it is detected on which side of the access control device a vehicle is located, in order to activate the display device on this side. In accordance with an extension of the invention, the display device can comprise a plurality of LEDs, which represent the text to be displayed depending on the activation of individual LEDs.

In the context of an extension of the invention, in addition to the transcribed text and to the identification data of the user, by means of the communication channel the GPS coordinates of the mobile electronic device can also be transmitted to the server, enabling the identification of the access control device to be simplified; since the access control device in this case is identified on the basis of the combination of GPS data and the transcribed text, i.e. the assignment of the text to an access control device, the displayed text can be very short, for example monosyllabic, which increases the transcript ion speed and also results in a minimum of transcription errors.

### BRIEF DESCRIPTION OP THE DRAWING

In the following an example of the invention is described in greater detail on the basis of the attached figure, which shows a flow diagram to illustrate the method according to the invention.

### DETAILED DESCRIPTION OF THE PREFERRED EMBODIMENTS

In the attached figure, the number 1 designates a mobile electronic device, wherein 2 represents an app installed in the mobile electronic device 1, 3 a barrier arm of an access control mechanism and 4 a server of an access control system for vehicles.

According to the invention, by means of a display device of the at least one access control device of an access control system, which display device faces an incoming vehicle in the access direction, a unique text assigned to the respective access control device is displayed, which due to the design and/or arrangement of the display device is only visible in a defined area around the access control device, in which under normal operating conditions only one vehicle can be located, wherein the displayed text is used to control the access control device in accordance with data transmitted to the access control system by a mobile electronic device 1, into which the text is dictated by a user.

In the example shown in the figure, an app 2 is installed on a portable electronic device 1 of the vehicle occupant of the vehicle, (step 1). If the vehicle is in the defined area in which a text displayed by the display device is visible, which is detected, for example, by means of an induction loop or a radar sensor (step 2), by means of a display device either mounted on the barrier arm 3 of the access control device or integrated in the barrier arm 3, a text assigned to this access control device is displayed (step 3), which is read by a vehicle occupant (step 4). The app 2 is then activated, which is preferably effected by a voice command, and the text is dictated by the user into the mobile electronic device 1 (step 5). In accordance with the invention, the dictated text is transcribed into a text by means of the app 2 (step 6) and via a suitable communication channel, for example by means of WLAN, Bluetooth Low Energy (BLE) or mobile radio, transmitted by means of the app 2 to a server 4 of the access control system together with identification data of the user, comprising at least one unique ID of the user or of the mobile electronic device 1 (step 7).

In the server 4, on the basis of the transmitted transcribed text the access control device is identified, in the access lane of which the user of the mobile electronic device 1 is situated in a vehicle directly in front of the junction between the area covered by the access control system and the area which is not covered by the access control system. In addition, the identification data of the user are evaluated (step 8), wherein based on a command transmitted by the server 4 to the access control device (step 9), the barrier arm 3 of the identified access control device is activated in the opening direction (step 10) if, upon entering the area covered by the access control system, the user is identified on the basis of the ID of the user or of the mobile electronic device 1 as a registered user, or if the user can be uniquely identified on the basis of the identification data of the user or if upon leaving the area covered by the access control system the necessary fees have been paid, which in the case of a registered user is effected by debiting his account or a credit card and in the case of a non-registered user by cash or credit card payment, wherein in the case of a registered user the payment of fees takes place automatically and in the case of a non-registered user during the payment the ID of the user or of the mobile electronic device 1 is scanned or transmitted via an app to the access control system.

1-12. (canceled)

13. A method for access control in an access control system for vehicles, comprising at least one access control device, the method comprising:
displaying, by a display device of the at least one access control device which faces an incoming vehicle in an access direction, a unique text assigned to a respective access control device which, due to a design and/or an arrangement of the display device, is only visible in a defined area around the access control device which, under normal operating conditions, only one vehicle can be located, and
using the displayed text to control the access control device in accordance with data transmitted to the access control system by a mobile electronic device (1) into which the text is dictated by a user.

14. The method for access control according to claim 13, further comprising changing the text displayed by the display device at specified time intervals.

15. The method for access control according to claim 13, further comprising permanently displaying the text displayed by the display device at specified periodic intervals or after detection of a vehicle.

16. The method for access control according to claim 13, further comprising transcribing the dictated text, by a piece of software in the mobile electronic device (1), into a text, and information items are transmitted via a communication channel to a server (4) of the access control system, which contain the transcribed text and identification data of the user, comprising at least one unique ID of the user or of the mobile electronic device (1), and, on a basis of the transcribed text, the access control device is identified, in an access lane of which the user of the mobile electronic device (1), or the person who is carrying of the mobile electronic device (1), is situated in a vehicle directly in front of a junction between an area covered by the access control system and an area which is not covered by the access control system, and activating a locking element (3) of the access control mechanism to which the transcribed text is assigned in the opening direction if, on entering the area covered by the access control system, the user is identified as a registered user on the basis of the ID of the user or of the mobile electronic device (1), or if the user can be uniquely identified on the basis of the identification data of the user, or, if on leaving the area covered by the access control system, the necessary fees were paid, which, in the case of a registered user, is effected by debiting a customer account or a credit card the registered user, and in the case of a non-registered user by cash or credit card payment, in the case of a registered user the payment of the fees is effected automatically, and in the case of a non-registered user during the payment the user ID of the user or of the mobile electronic device (1) is scanned or transmitted, via software in the mobile electronic device (1), to the access control system.

17. The method for access control according to claim 13, further comprising transcribing the dictated text, by a piece of software in the mobile electronic device (1), into a text, information items are transmitted via a communication channel to a server (4) of the access control system, said information contains the transcribed text and identification data of the user, comprising at least one unique ID of the user or of the mobile electronic device (1), on a basis of the transcribed text the access control device is identified, in an access lane of which the user of the mobile electronic device (1) or a person who is carrying the mobile electronic device (1) is situated in a vehicle directly in front of a junction between an area covered by the access control system and an area which is not covered by the access control system, upon driving into the area covered by the access control system, an electronic ticket is then sent by the server (4) to the mobile electronic device (1), via the communication channel, and a locking element (3) of the access control device, to which the transcribed text is assigned, is activated in the opening direction, wherein the fees are paid before exiting by a piece of software in the mobile electronic device and credit card data or at suitable machines, during the payment process the ID of the user or of the mobile electronic device (1) is transmitted to the server (4), upon exiting it is ascertained on the basis of the ID of the user or of the mobile electronic device (1) whether the fees have been paid, and
if this is the case, a locking element (3) of the access control device to which the transcribed text is assigned, is activated in the opening direction.

18. The method for access control according to claim 13, further comprising transmitting an audio file corresponding to the dictated text and identification data of the user who is carrying the mobile electronic device (1), comprising at least one unique ID of the user or of the mobile electronic device (1), via a communication channel and a piece of software in the mobile electronic device (1) to a server (4) of the access control system, transcribing in the server (4) the dictated text to a text, and on a basis of the transcribed text the access control device is identified, in an access lane of which the user of the mobile electronic device (1), or the person who is carrying the mobile electronic device (1), is situated in a vehicle directly in front of a junction between an area covered by the access control system and the area which is not covered by the access control system, and a locking element (3) of the access control mechanism to which the transcribed text is assigned is activated in the opening direction if, upon entering the area covered by the access control system, the user is identified as a registered user on the basis of the ID of the user or of the mobile electronic device (1), or if the user can be uniquely identified on the basis of the identification data of the user, or if on leaving the area covered by the access control system necessary fees were paid, which in the case of a registered user is effected by debiting a customer account or a credit card of the registered user and in the case of a non-registered user by cash or credit card payment, in the case of a registered user the payment of the fees is effected automatically, and in the case of a non-registered user during the payment the user ID of the user or of the mobile electronic device (1) is scanned or transmitted, via a piece of software in the mobile electronic device (1), to the access control system.

19. The method for access control according to claim 13 further comprising transmitting an audio file corresponding to the dictated text and identification data of the user who is carrying the mobile electronic device (1), comprising at least one unique ID of the user or of the mobile electronic device (1), via a communication channel and a piece of software in the mobile electronic device (1) to a server (4) of the access control system, transcribing in the server (4) the dictated text to a text and on a basis of the transcribed text the access control device is identified, in an access lane of which the user of the mobile electronic device (1) or the person who is carrying the mobile electronic device (1) is located in a vehicle directly in front of a junction between an area covered by the access control system and an area which is not covered by the access control system, upon driving into the area covered by the access control system, an electronic ticket is then sent by the server (4) to the mobile electronic device (1), via the communication channel, and a locking element (3) of the access control device, to which the transcribed text is assigned, is activated in the opening direction, the fees are paid before exiting by a piece of software in the mobile electronic device and credit card data or at suitable machines, as part of the payment process the ID of the user or of the mobile electronic device (1) is transmitted to the server (4), wherein upon exiting it is ascertained on the basis of the ID of the user or of the mobile electronic device (1) whether the fees were paid, and if this is the case, a locking element (3) of the access control device, to which the transcribed text is assigned, is activated in the opening direction.

20. The method for access control according to claim 18, further comprising also transmitting by means of the communication channel, in addition to the transcribed text and the identification data of the user, GPS coordinates of the mobile electronic device (1) to the server (4), and identifying an access control device on the basis of the combination of the GPS data and the transcribed text.

21. An access control system for vehicles comprising at least one access control device, for implementing the method according to claim 13, wherein the at least one access control device comprises a display device facing the incoming vehicles, by which a unique text, assigned to the respective access control device, is displayed, which, due to the design and/or arrangement of the display device, is only visible in a defined area around the access control device, in which only one vehicle can be located, and the displayed text can be used to control the access control device in accordance with data transmitted to the access control system by a mobile electronic device (1), into which the text is dictated by a user.

22. The access control system for vehicles according to claim 21, wherein the at least one access control device comprises a parking bollard and a barrier arm (3), and the display device is mounted on the barrier arm (3) or on the parking bollard or is integrated in the barrier arm (3) or in the parking bollard.

23. The access control system for vehicles according to claim 22, wherein the sides of the barrier arm (3) or of the parking bollard that are turned to face incoming vehicles in accordance with the access direction each have a display device, and on the basis of the signals from a sensor it is detected on which side of the access control device a vehicle is located, in order to activate the display device on this side.

24. The access control system for vehicles according to claim 23, wherein the display device comprises a plurality of LEDs which represent the text to be displayed depending on the activation of individual LEDs.
